(19) United States
(12) Patent Application Publication
(10) Pub. No.: US 2020/0399558 A1
(43) Pub. Date: Dec. 24, 2020

(54) METHODS FOR IDENTIFYING, COMPOUNDS IDENTIFIED AND COMPOSITIONS THEREOF

(71) Applicant: THE REGENTS OF THE UNIVERSITY OF CALIFORNIA, Oakland, CA (US)

(72) Inventors: Anandasankar RAY, Riverside, CA (US); Joel KOWALEWSKI, La Quinta, CA (US)

(73) Assignee: THE REGENTS OF THE UNIVERSITY OF CALIFORNIA, Oakland, CA (US)

(21) Appl. No.: 16/904,413

(22) Filed: Jun. 17, 2020

Related U.S. Application Data
(60) Provisional application No. 62/865,012, filed on Jun. 21, 2019.

(51) Int. Cl. C11B 9/00; A23L 27/00

(52) U.S. Cl. CPC C11B 9/00; A23L 27/88

(57) ABSTRACT

Provided herein are screening methods for identifying one or more compounds that impart a smell, taste and/or trigeminal sensation, for example, odorants contributing to an olfactory quality. Further provided are one or more compounds identified using the screening methods described herein, and compositions containing such compounds.

### CROSS REFERENCE TO RELATED APPLICATIONS

This application claims priority to U.S. Provisional Application Ser. No. 62/865,012, filed Jun. 21, 2019, which is hereby incorporated herein by reference in its entirety.

### FIELD

The present disclosure relates generally to the field of odor profiles and compounds thereof, and more specifically to identifying relationship between physicochemical features of odorants and odorant receptor activities, as well as identified compounds for use in fragrances and/or flavors.

### BACKGROUND

Human perceptual descriptions for olfactory stimuli are less stereotypic than for vision or auditory stimuli and may sometimes vary without an immediately apparent relationship to the molecular structure of the odorants or to the molecular/cellular organization of the olfactory system. Yet general neuroanatomical olfactory pathways are well conserved across species and the olfactory capabilities of humans appear closer to species that rely heavily on olfaction for survival and mating. While culture and language affect olfactory perception, these conserved parallels imply an important physicochemical and genetic basis for human olfactory perception. Genetic variation in olfactory receptors, for instance, explains a significant amount of variability in basic perceptual qualities of a chemical like intensity and prediction of more complex perceptual qualities from physicochemical features is increasingly plausible. Nevertheless, the breadth and complexity of the human olfactory perceptual space as well as its physicochemical correlates remain poorly understood except for a select few (<10). In part, because of the comparatively limited repertoire of olfactory receptors that have been functionally deorphanized and the relationship between physicochemical descriptions of odorants and odorant receptors remains unclear.

Thus, it remains interesting to research the biology of olfaction to discover the relationship between physicochemical features of odorants and odorant receptor activities. Furthermore, there is a need in the field of fragrances and/or flavors to identify chemicals that can be used alone or in combination with known ingredients in the design of new products.

### BRIEF SUMMARY

In one aspect, provided is a method for identifying one or more compounds that impart a smell, taste and/or trigeminal sensation. In some embodiments, one or more compounds are odorants contributing to an olfactory quality.

In another aspect, provided is a composition comprising at least one compound identified according to any one of the methods described herein. In some embodiments, one or more of such compounds are used in a flavor composition or fragrance composition which can satisfy diversified requirements for flavored/fragranced products, as well as to an odor-improving agent which can improve the quality and release of odor of a beverage, food, medicine or cosmetic.

### DESCRIPTION OF THE FIGURES

The present application can be best understood by references to the following description taken in conjunction with the accompanying figures.

FIGS. 1A-1E. Predicting odor character from physicochemical features using machine learning. FIG. 1A shows a pipeline for predicting ATLAS odor characters based on % usage, with “molasses” provided as an illustrative example. FIG. 1B illustrates the quality of predictions using the area-under-the curve (AUCs) from Receiver Operating Characteristic (ROC) plots. Average AUCs across train/test partitions for each odor character. Color coding reflects quartiles. Dashed red line is the mean AUC over all odor characters. FIGS. 1C and 1D are graphs of predicted vs observed % usage of randomly chosen odor characters for select test set chemicals. FIG. 1E shows ATLAS trained models of “sweet” and “warm” are used to predict % usage of the same odor characters from volunteers of a different study for 69 new chemicals. Significance is determined by t-test, compared to predictions with randomized predictor values (Null Model), *** p<0.001. Box plots reflect the distribution of predictions over 50 bootstrap samples.

FIGS. 2A-2D. Modeling the structural basis of human olfactory perceptual space. FIG. 2A depicts assembled network with significantly similar clusters of odor characters colored identically (with Louvain clustering). FIG. 2B is a schematic of factor analysis for extracting sets of linearly related odor characters from ATLAS. FIG. 2C shows that two sets (factors) are further separable based on connectivity among the top ten molecular descriptors. Connectivity between the sets of related odor characters is represented as combinatorial codes (fruity characters, top) and (sooty characters, bottom). FIG. 2D illustrates exemplar chemicals from the computationally inferred sub-clusters. Ratios indicating the degree of perceptual overlap for these chemicals are based on normalized % odor character usage.

FIGS. 3A and 3B. Computational screening of a large chemical space. FIG. 3A shows that models are used to predict odor characters from ˜440,000 compounds. A 2D representation of predictions for 15 hits for each character (or all chemicals that exceed a minimum % usage threshold), with edges connecting compounds that are predicted for multiple characters. The newly predicted chemicals are indicated as unnamed red dots, and each character as blue dots and labeled in rectangles. FIG. 3B (top) demonstrates that the network is subsequently examined for clustering and two separate representative clusters of related odor characters are marked (in green or red lettering). Individual chemicals can be displayed using spider plots (FIG. 3B, bottom left and bottom right) according to their predicted profiles relative to other chemicals in the entire space.

FIGS. 4A-4I. Identifying Odorant receptors to predict odor character indicates sparse coding. FIG. 4A shows models for each of the 146 odor characters. Each model comprised of a small number of molecular descriptors and one or few selected OR predictors. Each model was also tested with molecular descriptors and randomization of the selected ORs. Validation for each was performed across 50 identical train/test partitions and classification success measured by AUC. The OR labels in green denote positive and those in purple inverse relationships. Predictions of odor characters labeled in dark blue did not benefit from ORs. Light blue circles below odor character labels emphasize ones where the selection algorithms favored exclusively OR predictor sets; the comparison for these is between random versus non-random ORs. FIG. 4B depicts a tree representation of perceptual distance among odor characters based on behavioral data on the chemicals; FIG. 4C depicts a tree assembled using a binary matrix of the top 5 ORs picked per odor character; FIG. 4D depicts 5 randomly chosen ORs per odor character and the resulting tree; and FIG. 4E depicts a tree using the top 5 from the combined set of ORs and DRAGON descriptors. Clustering is hierarchical. Distances are Euclidian for perceptual data and Jaccard for all others. Cluster number (colored branches) inferred from gap statistic across bootstrap samples. FIG. 4F depicts workflow for applying machine learning to identify optimal predictors of odor valence in D. melanogaster from in vivo neural responses, molecular descriptors, and both together. FIG. 4G illustrates selection of optimal molecular descriptors for odor valence prediction after including in vivo neural activity as a predictor. FIG. 4H shows models of molecular descriptors and ab1C (neural responses) are tested using regularized linear regression (labeled “Linear Regression”) alongside a radial basis function SVM before and after removing ab1C. SVM: support vector machine. FIG. 4I shows a model: while an odorant may activate several different ORs, a specific character percept, for example “fruity citrus” is conveyed by activity of one OR type leading to a sparse coding model.

FIG. 5A illustrates (Left) the usage of sweaty supplied by general public respondents is predicted from key physicochemical features (DRAGON descriptors). Success is quantified by correlating predicted and observed % usage for an external set of chemicals, compared to a model with shuffled predictor values, ***p<0.0001. (Right) stability of predictions is assessed by randomly sampling from a pool of DRAGON descriptors that are potentially important in predicting “sweaty”. Few descriptors are actually needed to optimize predictions of % usage, “sweaty”. FIG. 5B illustrates (Left) key physicochemical features (DRAGON descriptors) are used to classify “cold” chemicals (Top % usage) as rated by the general public respondents. Successful prediction is quantified from the area under the ROC curve (AUC) for “holdout” sets (partitioning 407 odorants into train and test sets 250 times) and then again for a set of 69 external chemicals (Test set). (Right) the % usage of “musky” is similarly predicted. FIGS. 5C and 5D illustrate predictions of odor characters in ATLAS from DRAGON descriptors are assessed using alternative validation metrics and methods. FIG. 5C illustrates correlation between predicted and observed % usage. FIG. 5D illustrates mean absolute error for predictions of % usage (MAE). Plots reflect averages and standard deviations across 500 train/test partitions for each odor character; red horizontal lines signify the overall average.

FIG. 6A illustrates the 10 most important molecular (DRAGON) descriptors for predictions of odor character provide a network representation of the physicochemical basis of olfactory perceptual space. Connectivity in the network signifies shared molecular descriptors among 93 distinct odor characters and is used to infer clusters according to the Louvain algorithm. FIG. 6B illustrates (Left) discriminating top chemicals that smell like “cherry” versus “tar,” according to ATLAS study respondents. The discrimination success is quantified by the average AUC across 30 train/test partitions for models comprised of 1, 2, and 3 principal components (PC 1-3) that optimally retain information in the combined top 10 molecular (DRAGON) descriptors (20 total). Error bars reflect the standard error. Note the 3 component model provides perfect classification. (Right) exemplar chemicals for “cherry (berry)” and “tar” that are successfully discriminated despite structural similarity. FIG. 6C illustrates counts of the DRAGON descriptors selected in the top 10 for 146 odor characters with respect to broad categories. FIG. 6D illustrates (Top) euclidian distance between semantically similar and different odor characters in terms of % usage in ATLAS. (Middle and bottom) highly distant odor characters in sweet (bottom) and kerosene (middle) are linearly separable when plotting two top molecular (DRAGON) descriptors; MAXDP, a descriptor unique to sweet, and nDB (# double bounds) selected for both.

FIG. 7A illustrates workflow for training SVMs to learn binary encoded molecular or physicochemical features of ligands for 34 ORs. FIG. 7B illustrates a random subset of OR predictors is selected and an SVM model is repeatedly fit on 100 train/test partitions of the ATLAS training data (pictured 1 vs 138). Mean correlation between the predicted and observed % usage is reported across the train/test partitions. Subset of the best predicted odor characters is shown. FIG. 7C illustrates smallest, optimal OR predictor models are validated on 50 train/test partitions using multiple methods. Black vertical bars signify average over the top 50 models. Overlaying white bars signify performance using random OR values on the same 50 train/test partitions.

FIG. 8A illustrates pipeline whereby chemical features of ligands are encoded in binary and SVMs are trained on these features to assign probability scores to ATLAS chemicals (34 ORs). ORs with few known ligands are included by computing 3D pharmacophores and assigning similarity to ATLAS chemicals. The OR-ATLAS chemical similarity space is used for predictions of 146 odor characters and for assessing the importance of specific subsets of ORs. FIG. 8B illustrates a fixed number of ORs is randomly sampled (i.e., 1 vs 138). SVMs are then fit on different partitions of the ATLAS data and predict the % usage of chemicals excluded from the training partition. Top models shown based on the average correlation between predicted and observed % usage across 100 train/test partitions. Few ORs are needed to optimize predictions. FIG. 8C illustrates instead of randomly selected ORs, small sets of the most important ORs are validated, correlating (r) the predicted and observed % usage or classifying (AUC) chemicals with high % usage (50 train/test partitions). Black vertical bars signify the average over the top 50 models. Overlaying white bars signify performance using random OR values on the same 50 train/test partitions.

FIG. 9A illustrates utility of human odorant receptor response data in predicting % odor character usage from general public volunteers (Keller and Vosshall, 2016), abbreviated as “Keller 2016.” OR predictors are randomly selected and % usage of odor characters is predicted using a SVM across 100 train/test partitions for odorants at 1/1,000 dilution. Results filtered to top 10 best-performing models. FIG. 9B illustrates an identical procedure is applied to odorants and replicates at 1/100,000. Multiple odorants overlap between the two dilution sets. FIG. 9C illustrates the 5 best ORs are tested for successful classification of the top % usage odorants. Best performing models shown (50 train/test partitions). FIG. 9D illustrates (Left) a single OR predictor (OR10G7) is added to optimal DRAGON descriptors for classifying % usage of “cinnamon” in ATLAS, increasing the sensitivity (true positive rate). (Right) addition of OR2W1 to optimal DRAGON descriptors improves predictions of % usage of “dill” character. For clarity, the same degree of jitter has been added to suppress overlapping points in plots for the 500 train/test partitions and error bars reflect the standard deviation for models with and without OR2W1.

### DETAILED DESCRIPTION

The following description is presented to enable a person of ordinary skill in the art to make and use the various embodiments. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

### Screening Methods

Provided herein are screening methods for identifying one or more compounds that impart a smell, taste and/or trigeminal sensation. In some embodiments, the one or more compounds are odorants contributing to an olfactory quality.

In some embodiments, chemical features that are predictive are identified and used to predict new chemicals from natural sources and/or known libraries. In some embodiments, models rank the chemicals allowing for the selection of a smaller set of candidates that are suitable for experimental validation.

### Candidate Compounds

The screening methods provided herein may be used to screen one candidate compound or a plurality of candidate compounds. The one or more candidate compounds may be natural or synthetic compounds. For example, the one or more candidate compounds may be from bacterial, fungal, plant and animal extracts that are commercially available or readily produced. The one or more candidate compounds can also be chemically-modified compounds, such as by acylation, alkylation, esterification, or acidification of natural compounds. The one or more candidate compounds screened in the methods described herein may be pre-selected based on one or more criteria. A computation method may be used to select such candidate compounds. In some embodiment, compounds are screen for the smell (e.g., natural fragrances, aromas, or odors). Other criteria that can be used for selecting the one or more candidate compounds include the environmental impact of the compounds, and regulatory approval of the compounds for human consumption (e.g., FDA-approval).

In some embodiments, a method to computationally identify chemicals predicted for each percept, comprising using Dragon Physicochemical descriptors as shown in Table 43 (see Appendix A).

### Compounds Identified and Compositions Thereof

The following compounds have been identified using the methods and systems described herein. One or more of such compounds may be used in a fragrance or flavor composition. Without being bound to any particular theory, compounds described herein could impart a smell, taste and/or trigeminal sensation, such as cooling sensation. For example, it is believed that odors are associated with hot and cold temperature, since odor processing may trigger thermal sensations, such as coolness in the case of mint.

In addition to the one or more compounds described herein, a flavor component and/or a fragrance component ordinarily used, such as various synthetic aromachemicals, natural essential oils, synthetic essential oils, citrus oils, animal aromachemicals, can be used in the fragrance or flavor composition. For example, a wide range of the flavor components and/or fragrance components, such as described in, for example, Arctander S., “Perfume and Flavor Chemicals”, published by the author, Montclair, N.J. (U.S.A), 1969, can be used as an additional flavor component and/or a fragrance component. Exemplary components include, but are not limited to, α-pinene, limonene, cis-3-hexenol, phenylethyl alcohol, styrallyl acetate, eugenol, rose oxide, linalool, benzaldehyde, muscone, Thesaron (a product of Takasago International Corporation), ethyl butyrate, and 2-methylbutanoic acid. In some embodiments, the additional flavor component and/or a fragrance component is a flower-based or fruit-based flavor and/or fragrance component.

In some embodiments, the flavor composition or fragrance composition containing one or more of the compounds described herein further contains at least one kind of fixing agent known in the art. Exemplary fixing agents include, but are not limited to, ethylene glycol, propylene glycol, dipropylene glycol, glycerine, hexylene glycol, benzyl benzoate, triethyl citrate, diethyl phthalate, Hercolyn, medium chain fatty acid triglyceride, and medium chain fatty acid diglyceride.

By adding the flavor composition or fragrance composition containing one or more of the compounds described herein alone or in combination with additional components, to, for example, a beverage, a food, an oral-care composition, a medicine, a fragrance product, a skin-care preparation, a make-up cosmetic, a hair cosmetic, a sunblock cosmetic, a medicated cosmetic, a hair-care product, a soap, a body cleaner, a bath preparation, a detergent, a fabric softener, a cleaning agent, a kitchen cleaner, a bleaching agent, an aerosol, a deodorant-aromatic, or a sundry, in an appropriate amount capable of imparting the odor of one or more of the compounds used, there can be provided a product added with a flavor or a fragrance. In some embodiments, a product added with a flavor composition or fragrance composition containing one or more of the compounds described herein is a beverage or food. In some embodiments, a product is a fragrance product such as perfume, eau de perfume, eau de toilette, cologne, etc. In some embodiments, a product is a skincare product. In some embodiments, a product is oral-care product. In some embodiments, a product is a cosmetic such as foundation, face powder, pressed powder, talcum powder, lipstick, rouge, lip cream, cheek rouge, eye liner, mascara, eye shadow, eyebrow pencil, eye pack, nail enamel, enamel remover, etc. In some embodiments, a product is a hair-care or body-care product. In some embodiments, a product is a suntan cosmetic, suntan product, sunscreen product, etc. In some embodiments, a product is medicated cosmetic, antiperspirant, after shave lotion and gel, permanent wave agent, medicated soap, medicated shampoo, medicated skin cosmetic. In some embodiments, a product is a chewing gum.

In some embodiments, the flavor composition or fragrance composition contains one or more of the compounds described herein which have an odor that reminds a fruit, food, flower, spice, etc. In some embodiments, the odor is associated with a natural odor from one or more substances, for example, almond, anise/licorice, aromatic, banana, cantaloupe/honeydew, cedarwood, cherry/berry, cinnamon, clove, coconut, coffee, cologne, flower, fragrance, fresh tobacco/smoke, fruit/citrus, fruit other than citrus, garlic/onion, geranium leaves, herbal green/cut grass, incense, lavender, leather, lemon, medicine, mint/peppermint, musk, oak wood/cognac, orange, peach fruit, pear, perfume, pineapple, rose, soap, spice, strawberry, sweet, vanilla, violets, woody resins, and combinations thereof. In some embodiments, the flavor composition or fragrance composition contains one or more of the compounds described herein which impart cooling sensation along or together with other compounds identified there in and/or components known in the art.

In some embodiments, the composition is formulated as a lotion, a gel, a cream, a foam, a spray, a suspension or an emulsion. In some embodiments, the composition in formulated into a dust, a vaporizer, a treated mat, a treated outerwear, an oil, a candle, or a wicked apparatus.

In some embodiments, the compound identified according to the methods and systems described herein are selected from Tables 1-42 containing SMILES structures below. Provided are also compositions including one or more, two or more, or three or more compounds selected from Tables 1-42 as shown in Appendix A.

In some embodiments, the composition containing one or more compounds selected from Table 1 has the odor associated with almond. In some embodiments, the composition containing one or more compounds selected from Table 2 has the odor associated with anise/licorice. In some embodiments, the composition containing one or more compounds selected from Table 3 has the odor associated with aromatic. In some embodiments, the composition containing one or more compounds selected from Table 4 has the odor associated with banana. In some embodiments, the composition containing one or more compounds selected from Table 5 has the odor associated with a cantaloupe/honeydew. In some embodiments, the composition containing one or more compounds selected from Table 6 has the odor associated with cedarwood. In some embodiments, the composition containing one or more compounds selected from Table 7 has the odor associated with a cherry/berry. In some embodiments, the composition containing one or more compounds selected from Table 8 has the odor associated with cinnamon. In some embodiments, the composition containing one or more compounds selected from Table 9 has the odor associated with clove. In some embodiments, the composition containing one or more compounds selected from Table 10 has the odor associated with coconut. In some embodiments, the composition containing one or more compounds selected from Table 11 has the odor associated with coffee. In some embodiments, the composition containing one or more compounds selected from Table 12 has the odor associated with cologne. In some embodiments, the composition containing one or more compounds selected from Table 13 imparts cooling sensation. In some embodiments, the composition containing one or more compounds selected from Table 14 has the odor associated with a flower. In some embodiments, the composition containing one or more compounds selected from Table 15 has the odor associated with fragrance. In some embodiments, the composition containing one or more compounds selected from Table 16 has the odor associated with fresh tobacco/smoke. In some embodiments, the composition containing one or more compounds selected from Table 17 has the odor associated with fruit/citrus. In some embodiments, the composition containing one or more compounds selected from Table 18 has the odor associated with fruit other than citrus. In some embodiments, the composition containing one or more compounds selected from Table 19 has the odor associated with garlic/onion. In some embodiments, the composition containing one or more compounds selected from Table 20 has the odor associated with geranium leaves. In some embodiments, the composition containing one or more compounds selected from Table 21 has the odor associated with herbal green/cut grass. In some embodiments, the composition containing one or more compounds selected from Table 22 has the odor associated with incense. In some embodiments, the composition containing one or more compounds selected from Table 23 has the odor associated with lavender. In some embodiments, the composition containing one or more compounds selected from Table 24 has the odor associated with leather. In some embodiments, the composition containing one or more compounds selected from Table 25 has the odor associated with lemon. In some embodiments, the composition containing one or more compounds selected from Table 26 has the odor associated with medicine. In some embodiments, the composition containing one or more compounds selected from Table 27 has the odor associated with mint/peppermint. In some embodiments, the composition containing one or more compounds selected from Table 28 has the odor associated with musk. In some embodiments, the composition containing one or more compounds selected from Table 29 has the odor associated with oak wood/cognac. In some embodiments, the composition containing one or more compounds selected from Table 30 has the odor associated with an orange. In some embodiments, the composition containing one or more compounds selected from Table 31 has the odor associated with peach fruit. In some embodiments, the composition containing one or more compounds selected from Table 32 has the odor associated with a pear. In some embodiments, the composition containing one or more compounds selected from Table 33 has the odor associated with a perfume. In some embodiments, the composition containing one or more compounds selected from Table 34 has the odor associated with a pineapple. In some embodiments, the composition containing one or more compounds selected from Table 35 has the odor associated with a rose. In some embodiments, the composition containing one or more compounds selected from Table 36 has the odor associated with soap. In some embodiments, the composition containing one or more compounds selected from Table 37 has the odor associated with spice. In some embodiments, the composition containing one or more compounds selected from Table 38 has the odor associated with strawberry. In some embodiments, the composition containing one or more compounds selected from Table 39 has the odor associated with sweet. In some embodiments, the composition containing one or more compounds selected from Table 40 has the odor associated with vanilla. In some embodiments, the composition containing one or more compounds selected from Table 41 has the odor associated with violets. In some embodiments, the composition containing one or more compounds selected from Table 42 has the odor associated with woody resinous.

### EXAMPLES

The following examples are merely illustrative and are not meant to limit any embodiments of the present disclosure in any way.

The fundamental units of olfactory perception are discrete 3D structures of volatile chemicals that each interact with specific subsets of a large family of odorant receptor proteins (˜400), in turn activating complex neural circuitry and posing a challenge to understand. We have applied computational approaches to analyze olfactory perceptual space from the perspective of odorant chemical features. We identify physicochemical descriptor sets that describe each of ˜150 different odor characters and use Machine Learning to map them onto a chemical space of nearly 0.5 million compounds. The chemical structure-to-percept prediction is improved significantly for >100 characters using the activities of specific human odorant receptor combinations. Using a tractable model Drosophila, additional support was found for a model where only a few receptors contribute to odor character of a chemical. This study provides a systems-level view of human olfaction and opens the door for comprehensive computational discovery of fragrances and flavors.

### Materials and Methods

Psychophysical data: Data from 55 general public volunteers were used for external validation. Due to limited diversity in the selection of odor descriptors supplied by naíve volunteers and evidence indicating experience with odor language improves the quality of perceptual data, a sample of industry professionals as reported in the atlas of odor character profiles (ATLAS) was primarily considered. Notably, the semantic descriptors (odor characters) were sparsely used in some cases among the general public volunteers, suggesting that averaged ratings for a given descriptor (odor character) could be restricted to a small percentage of the compounds and respondents. For the purposes of generating predictive models for all available chemicals, these missing data points must be dealt with such as by averaging ratings for the nearest neighboring (k) odorants or filling in with the median/mean across all odorants. While these approaches are valid in predictive modeling, this is a significant modification of the respondent data, where the failure to respond is possibly meaningful information, and limits any analysis of the human olfactory perceptual space. As a result, the 0-100 scale for the general public volunteer data were maintained but converted ratings to a % usage metric instead. The data also were not averaged over replicates or dilutions, but relied instead on training sets that contained a single concentration, 1/1000 or 1/100,000. Although with the % usage odorants are assigned numeric values more naturally, this modification was similarly in line with the ATLAS study data. The % usage therefore provided a means to compare two sources that to a first approximation appear very different.

Atlas of odor character profiles (ATLAS): ATLAS summarizes odor profiles for 180 odorants, replicates and mixtures, with the latter not being used for predictions, from 507 industry professionals across 12 organizations, a total that does not reflect the number of participants rating the full odor panel. The participants scored a set of replicates, which were used to provide an index of discriminability for the data as the inverse of the squared correlation coefficient, or RV=0.11. Accordingly, any two odorants whose difference was less than 0.11 on the scoring metric could not be differentiated for this sample. The scoring metric was on the range of 1-5 with 1 being slightly and 5 being extremely relevant. Raw scores were subsequently processed into two numeric values summarizing the participants' responses. In these Examples, it was focused on the % usage; the fraction of participants providing any response, 1-5. The descriptor (or character) set available for the study was extensive but empirically driven. Recommendations from the ASTM sensory evaluation committee winnowed an initial set of 800 possible odor characters for sensory analyses down to 160. Prompted by additional research, this figure was later revised to 146 relevant characters, a final set that addressed concerns in which clear perceptual differences could result in identical descriptor usage from study participants. This final set of 146 characters and the percent usage was subsequently prepared for machine learning analyses.

Clustering perceptual descriptors and other unsupervised learning analyses: ATLAS and the volunteer data from the general public were analyzed using hierarchical clustering. Appropriate cluster size was reported using the gap statistic and the 1-SE rule. Values were scaled to a mean of 0 and standard deviation of 1. All analyses were carried out in R using the hclust function, Euclidian distance with the Ward D2 method for hierarchical clustering. The distance metric was replaced with 1-Jaccard index when the matrices were binary. Factor analysis on ATLAS data was run using the factanal function in addition to functions in the nFactors R package for factor extraction.

Selecting optimally predictive molecular features: Molecular features were computed with DRAGON 6 for ATLAS. Compounds were initially optimized and 3D coordinates computed with OMEGA. Molecular features were pre-computed and made publicly available for DREAM and used as is for public volunteers. Molecular feature rankings were assigned using four different approaches: sequential forward selection (SFS), a greedy optimization that involves iterating over the predictor space to grow a predictor set that maximizes the correlation with the outcome or target being predicted (% odor character usage). Stopping criteria are used to restrict the search. This approach, while computationally efficient in high dimensional predictor spaces, is insensitive to non-linearity. To compensate for this, additional approaches were applied that use random forest models to determine feature importance. Random forest is an extension of basic decision trees that overcome the often poor generalizability of these models by aggregating the predictions from multiple trees trained on bootstrap samples and different predictor sets, effectively limiting redundancy between trees. Rows that are excluded as part of bootstrapping process are used to estimate prediction performance on new data. This also provides a method for assigning importance to features through randomization. The % increase in prediction error after randomizing a feature is accordingly the ranking metric that was used as the starting point for mapping molecular descriptors onto the differing percepts.

Boruta and permutation variable importance (PIMP) are algorithms that can wrap the random forest importance values, applying further randomization to converge upon an optimal, reduced set of predictors. Boruta includes a two sample comparison (random versus non-random) to resolve predictor significance for borderline cases. A bonferroni corrected significance threshold of p<0.01 was applied here to correct for multiple comparisons. Alternatively, the approach outlined by Altman and colleagues assembles its own null predictor importance distribution that is derived from iteratively randomizing the target or outcome. P-values here thus denote the rarity of the computed importance for the non-randomized features in this null distribution, i.e., p<0.05. The last approach applied, a cross-validated recursive feature elimination (RFE) with random forest, simply modifies the traditional RFE algorithm by initially partitioning the training data into multiple folds or resamples to avoid biasing estimates (selection bias) of the effectiveness of models when validation data are limited. Aggregating importance across these different instances or folds of the training data provides a potentially more generalizable set of features with less bias. This concern was particularly relevant for the ATLAS data. In addition to these methods, we used a hidden test set and also made efforts to show the models could be used to predict perceptual responses from a completely different experiment, removing methodological biases arising from odorant preparation and presentation or any unforeseen regularities that machine learning algorithms could exploit but that are fundamentally task irrelevant for the analyst or researcher interested understanding rather than predicting.

Algorithm search for predicting perceptual profiles: The success or failure of earlier efforts was used to guide our search for optimal algorithms on the ATLAS data. This included several boosted tree implementations including eXtreme gradient boosting that were highly variable in predicting holdout data and abandoned early on. Subsequently, a support vector machine (SVM) with the radial basis function kernel (RBF) outperformed random forest, regularized linear models (ridge and lasso), and linear SVM, tuning over L1 versus L2 regularization. The favorable performance when using a non-linear decision boundary suggested a complex relationship between the molecular features and the perceptual profiles for the ATLAS data. Gradient boosted decisions trees and tree ensembles such as random forest nevertheless approximated performance of RBF SVMs on the public volunteer data, and in certain cases outperformed it, emphasizing that the choice of optimal algorithm is context-dependent. However, to ensure consistency in our analysis of different psychophysical data sources we did not report the results in this manner, that is, fitting the best performing algorithm each time. Instead meta algorithms such as bootstrap aggregating (bagging) were incorporated to improve generalizability of the RBF SVM. This ensemble (bagging) approach was favored whenever predicting non-ATLAS data (cross-study prediction). Algorithm selection and training was done using the classification and regression training package in R, caret.

Network modeling of the combined chemical and perceptual spaces: Chemical and perceptual spaces were modeled as bipartite graphs from an incidence matrix with percepts as rows and columns the combined, unique optimal molecular feature sets. Such matrices denote the optimal molecular features for a given percept as 1, otherwise 0. Collectively, these binary strings are likened to a set of combinatorial codes for the ATLAS perceptual space. The bipartite graph for clarity was subsequently separated into its constituent, adjacency matrices, which are symmetrical, m×m and n×n, matrices, with m denoting rows (percepts) and n the columns (molecular features) in original incidence matrix. Several methods are available for identifying modules, communities or clusters in networks assembled from adjacency matrices. Several were tested selecting the Louvain algorithm based on its higher modularity score for ATLAS data. Actual or observed network properties were in turn compared to 10,000 random network simulations (Erdos-Renyi) of approximately identical size and density. The actual network properties differed from those generated through the random simulation. Similarly, small-world properties were estimated in relation to random graphs, e.g., transitivity over the average shortest path length, normalized by the values obtained from 1000 random graphs (small-world index=3), and it was confirmed that few (˜300) key descriptors could predict the odor character descriptors provided by humans for 100 new chemicals (semantic similarity>0.5). Graph analyses were done using the igraph package in R, plots with ggplot2 and functions from the ggnetwork package, as well as additional custom scripts.

Relevancy of odorant receptors in predictive models: Despite several available data sources, most in vitro assays typically report a handful of ORs with multiple agonists and many others that appear highly selective (1 or 2 compounds that pass statistical thresholds). To incorporate the more narrowly tuned receptors, we used 3D pharmacophores to construct structural similarity matrices of ATLAS compounds to known ligands. In cases where there were >1 ligands for an OR the maximally similar ligand was used. Because an exact or even approximate 3D similarity calculation can be computationally taxing, particularly for large aromatic compounds, SVM models were trained to learn physicochemical features of the confirmed ligands for a subset of ORs whose response profiles are currently better characterized. Different chemical features were encoded as binary fingerprints (1,0) (Klekota-Roth, Morgan/Circular, MACCs, Shortest Path, and Hybridization). Chemical fingerprints can encode up to ˜1000 bits and many are possibly uninformative. Therefore Kullback-Leibler (KL) divergence was used to select only those bits that maximized the distance between active and inactive compounds in the heterologous assay data. Predictions from these models provided probability scores for each OR-ATLAS pair. Molecular descriptors and fingerprints for this work relied on DRAGON 6, the chemistry development kit (CDK), and its implementation in R (rcdk), including RDKit through Python.

### Model Performance Metrics for Quantification and Statistical Analysis

AUC: The area under the roc curve assesses the true positive rate as a function of the false positive rate (1-specificity) while varying the probability threshold for a label (active/inactive). Integrating the curve provides an estimate of classifier worth, with the top left corner giving an AUC of 1.0 denoting maximum sensitivity to detect all target labels in the data without any false positives. The theoretical random classifier is traditionally reported at 0.5. However, throughout we generated more authentic random classifiers, shuffling the molecular feature (or ORs) values in the optimal model and statistically comparing the mean AUCs across multiple resamples of the test set data. This metric was used for classification but also for assessing ranking performance within regression models. Namely, the performance of the SVM to properly rank the % usages for the data withheld from training.

RMSE: Root mean squared error is the square root of the mean difference between predicted values and those observed (% usage). It is the average prediction error on the scale of the target or outcome being predicted. We supplied these values as the magnitude of the R squared or the correlation coefficient (r) is not always an accurate representations of model performance. We nevertheless reported the correlation coefficient, r, between the predicted and the observed % usage due to its previous use with human perceptual data.

MAE: Mean absolute error is the mean of the absolute difference between predicted and observed (% usage). It thus assigns equal weight to all prediction errors, whether large or small.

### Discussion and Results

There is an intriguing possibility that descriptions humans use to characterize odorants are clearly associated with a set of key physicochemical features of the odorants or with a set of odorant receptor activities.

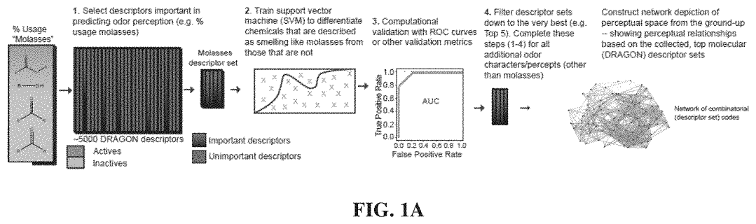

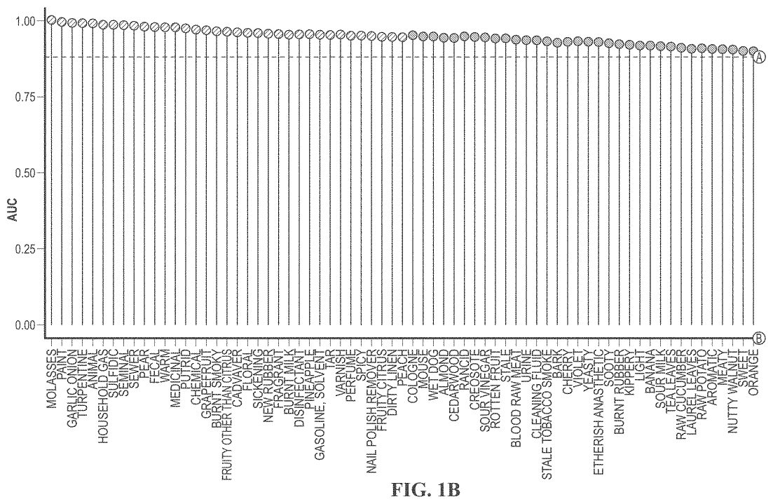

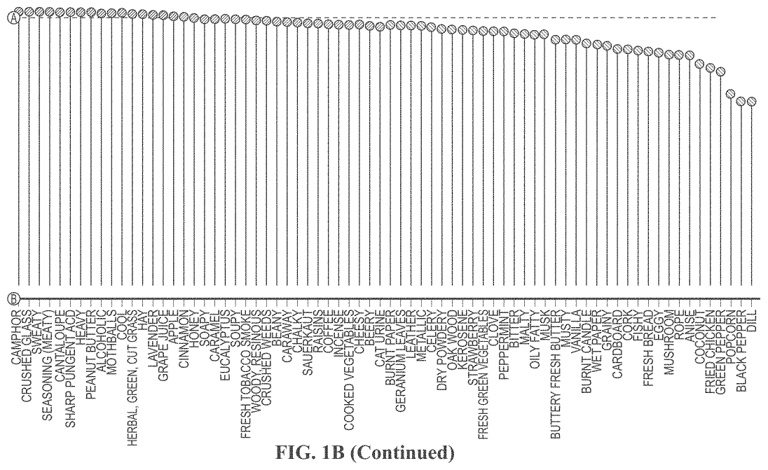

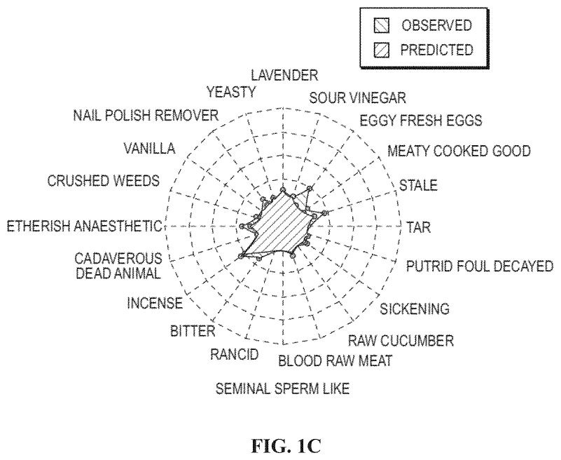

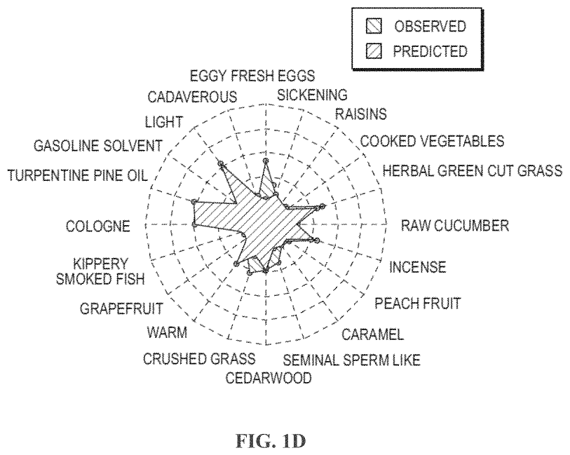

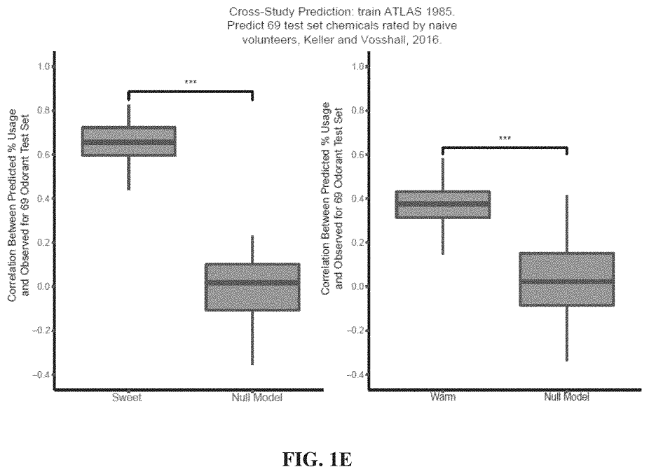

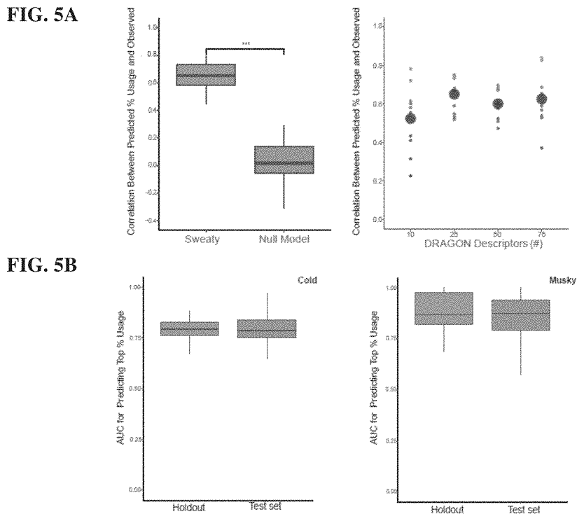

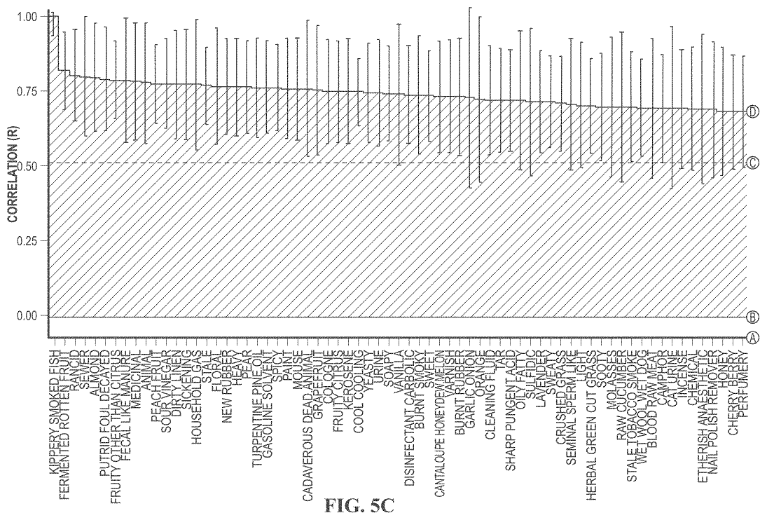

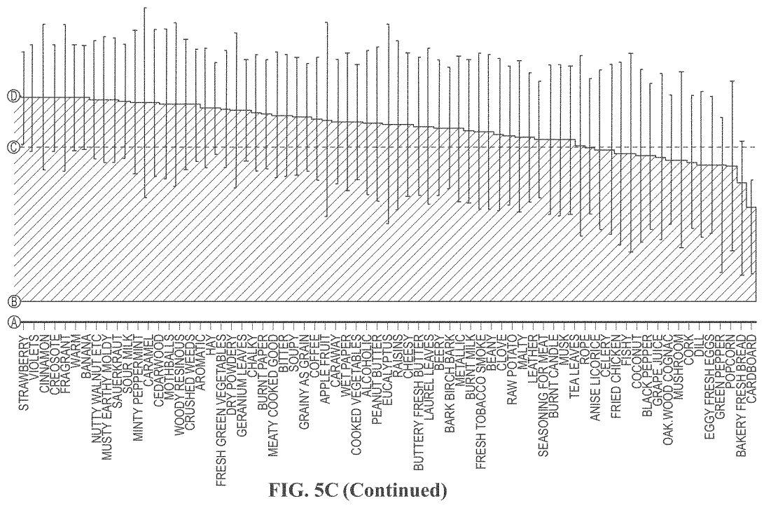

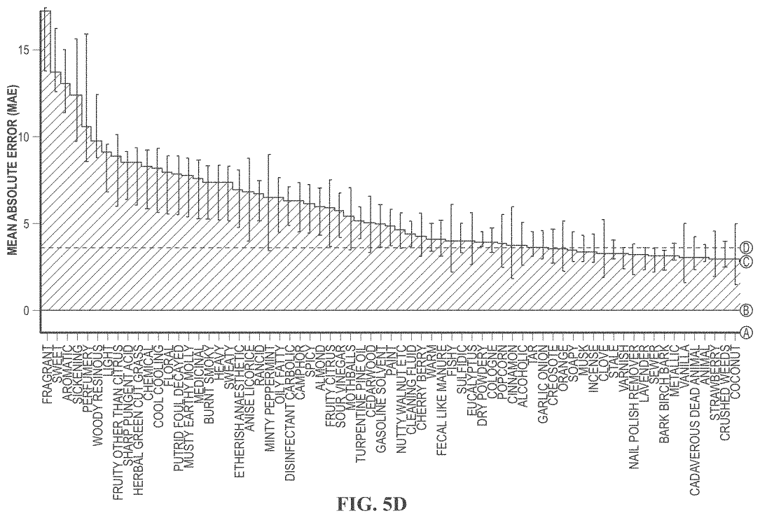

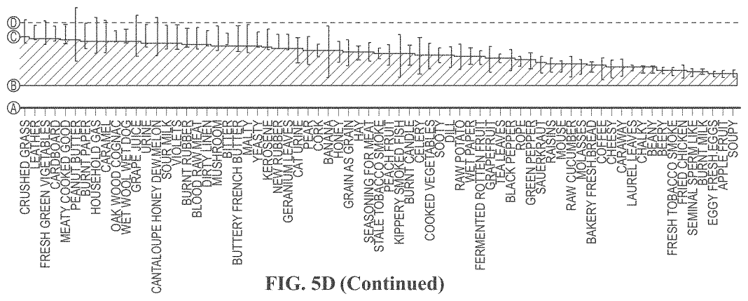

In order to test this possibility a computational pipeline was develop to successfully predict odor character from chemical structure for 146 different odor characters. First, chemical features that contribute most to each odor character were computationally identified (FIG. 1A). A systems-wide network analysis of these features reveals the physicochemical basis of different odor characters. Next, we use machine learning (ML) to train models to successfully predict 146 different odor characters from a known set of 138 chemicals behaviorally tested in the ATLAS survey (FIG. 1A), as well as for odor characters that had proven challenging to predict in earlier studies (FIGS. 5A and 5B).

The initial step involved searching a physicochemical feature space of DRAGON descriptors, selecting the most important descriptors among the ˜5000 available for each of 146 ATLAS odor characters. Models consisting of the most important descriptors are then rigorously evaluated on test data (FIG. 1A). Although many of the 146 characters are complex and without a well-defined physicochemical basis, individual DRAGON descriptor sets successfully classified the odor characters with significant success (avg. AUC=0.88) (FIGS. 1B, 5C, and 5D). Odor character predictions for external test chemicals also agreed with human volunteers (FIG. 1C and FIG. 1D). Remarkably, models for “sweet” and “warm” from the 1985 ATLAS study were successful at predicting “sweet” and “warm” chemicals, as determined by the volunteers from a later 2016 study that used different odors and methodologies (FIG. 1E). These results suggest that odor characters can be successfully predicted from physicochemical features alone. And while the human perceptual space remains poorly characterized, it can be comprehensively mapped onto a chemical space using our machine learning method.

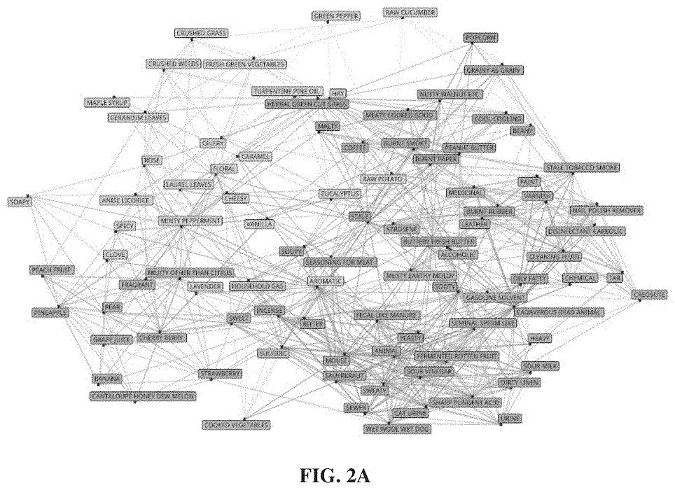

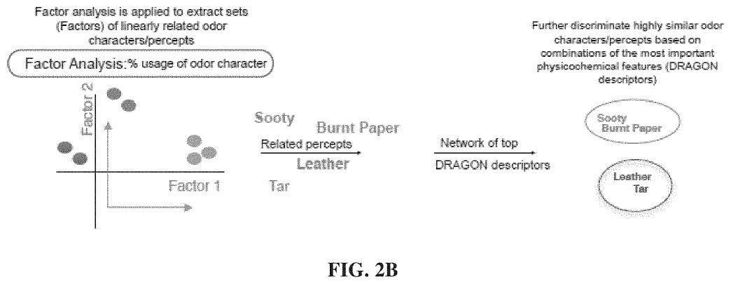

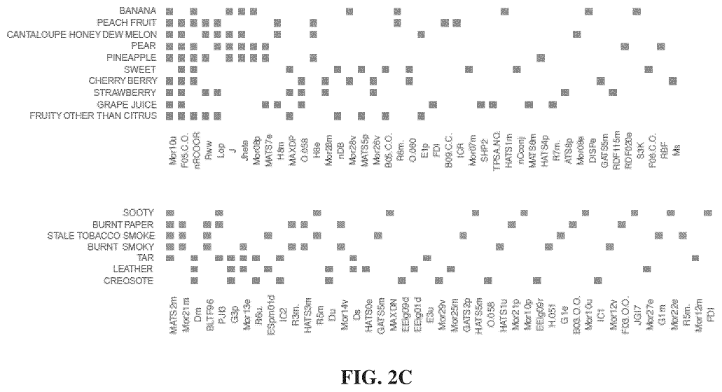

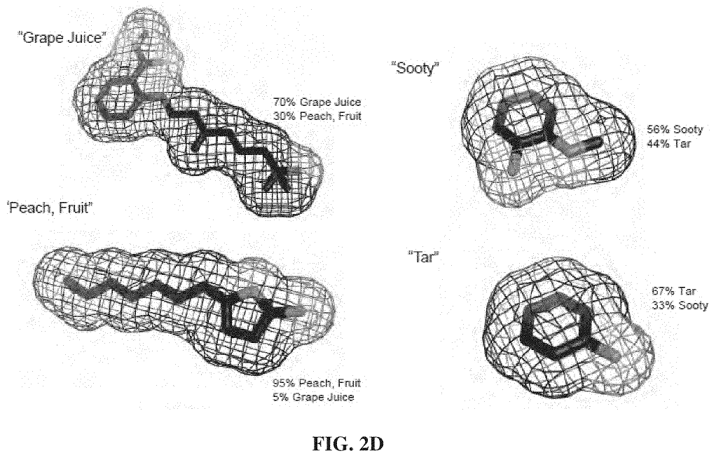

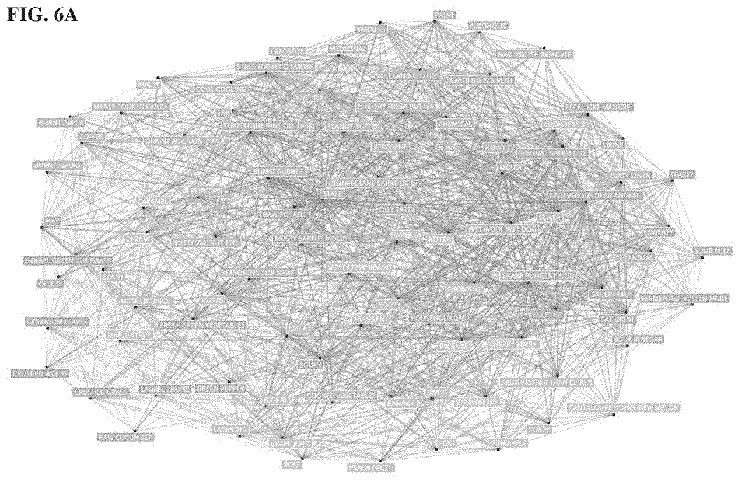

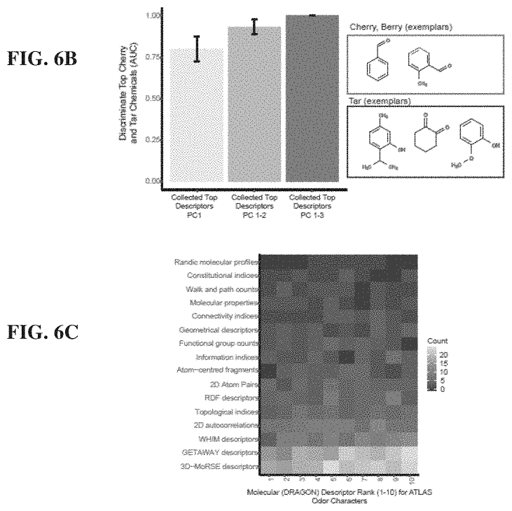

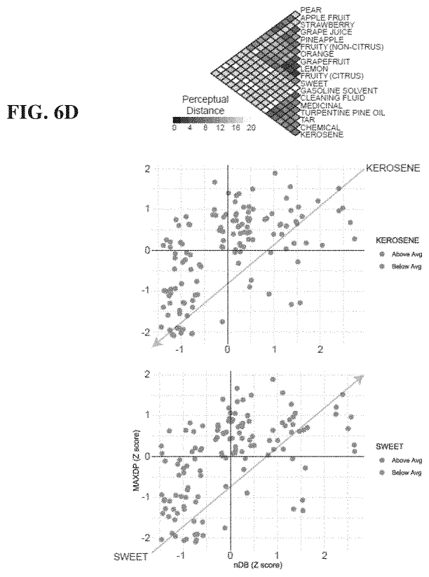

Next, the odor characters in networks were arranged, connecting characters when their top physicochemical (DRAGON) descriptors were shared (FIG. 2A and FIG. 6A). Using only the top 3 DRAGON descriptors for each character (117 unique) we could assemble a fully connected network and found highly structured regions or clusters among 93 of the most distinct odor characters, with the clusters becoming progressively more specific alongside greater network connectivity as we increased the number of DRAGON descriptors to the top 5 (FIG. 2A). The structure (or clusters) detected within these networks, while consistent with prior interpretations of the human perceptual space, is not necessarily expected from such a small number of physicochemical features. Interestingly, the networks do however retain properties that are prevalent in biological systems.

To more rigorously test whether these chemical-percept networks were indeed a meaningful representation of human perceptual space, characters that were closely related were focused on since the olfactory system is tasked with discriminating similar smelling chemicals, possibly by detecting key physicochemical features (FIG. 2B). Despite the relatedness, just like the human olfactory system is able to, the computer could infer separate sub-clusters based only on the presence or absence of key molecular (DRAGON) descriptors (FIG. 2C, top and bottom). Representative compounds for related but computationally distinct odor characters as “grape juice” and “peach, fruit” or “sooty” and “tar” are subtly different in molecular descriptors (FIGS. 2C and 2D). The feature differences appear so slight that it is evident how these compounds might elicit similar perceptual ratings in humans, and yet algorithms are capable of identifying a small number of discriminating physicochemical features, consistent with different percepts. the key physicochemical features could be equally used to successfully address the alternative scenario of discriminating clearly distinct percepts that arise from structurally similar chemicals (FIG. 6B).

An in-depth analysis of the high ranking features comprising these networks suggested that 3D structure is an important determinant of accurate predictions, particularly the 3D-MoRSE and GETAWAY family of molecular (DRAGON) descriptors (FIG. 6C), which are representations of 3D structure weighted by additional physicochemical properties. Simpler 2D descriptors and functional group counts appeared less common throughout the rankings but also proved useful (FIG. 6D). Interestingly, combinatorial effects of physicochemical descriptors are observed to play a major role. For example, “sweet” or “kerosene” smelling chemicals are distant in perceptual space in the ATLAS dataset, even though they share a top descriptor nDB (numbers of double bonds) and are therefore connected in FIG. 2A. However, with the addition of a single descriptor that ranked highly only for “sweet”, MAXDP (sensitive to electrophilicity), we observed separation between the characters in olfactory-chemical space, consistent with differences in the study participants' responses. This illustrates how combinations of a small number of key physicochemical descriptors and their values can account for many diverse odor characters.

The main challenge to creating a comprehensive representation of olfactory perception ultimately depends on overcoming limitations of low throughput human subject data by extending analyses to large, unexplored chemical spaces. Given the high success rates we achieved for predictability, 146 odor character models were used to predict from a large, chemical space of a ˜440,000 compound library. ˜68 million character-compound combinations were evaluated and numerous (hundreds to thousands) new compounds that smell like each of 146 odor characters were predicted. These chemicals represent a massive expansion (>3000 times) of the previously known odor-character chemical space and is likely to cover a substantial fraction of putative volatile molecules with properties related to odorants. The top 100 chemicals predicted from the ˜440,000 for each of the 146 odor characters are available. Although the prediction success rate for each character may vary, in general levels >70-80% were anticipate based on the computational validation tests we performed for each character. Ultimately, this allowed us to create, for the first time, a comprehensive odor-character chemical space based on predictions.

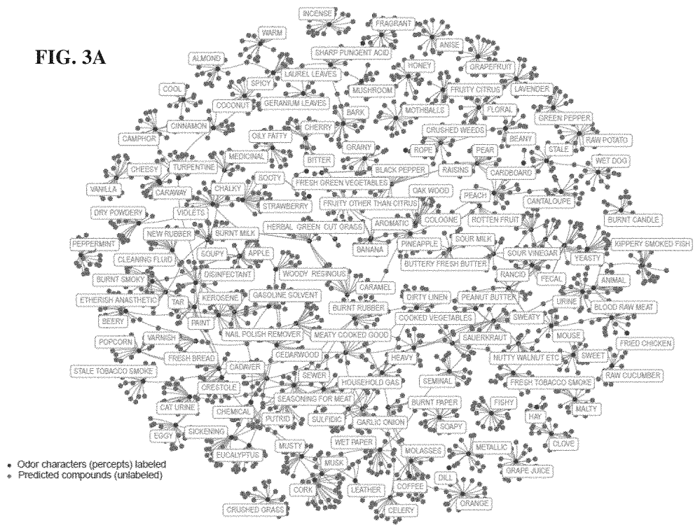

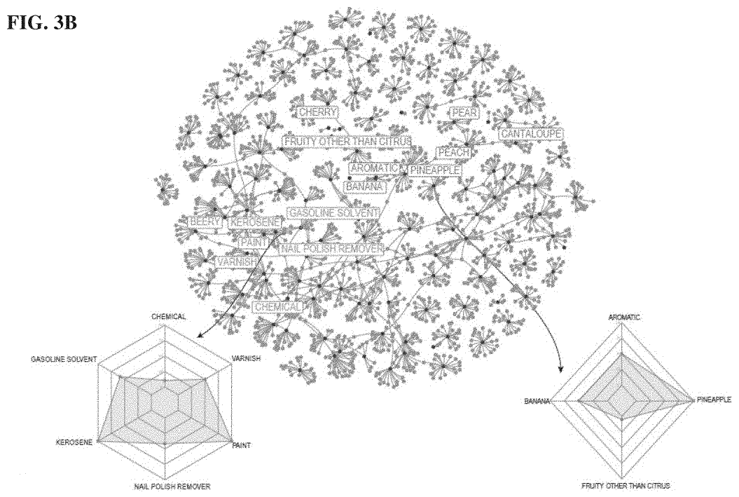

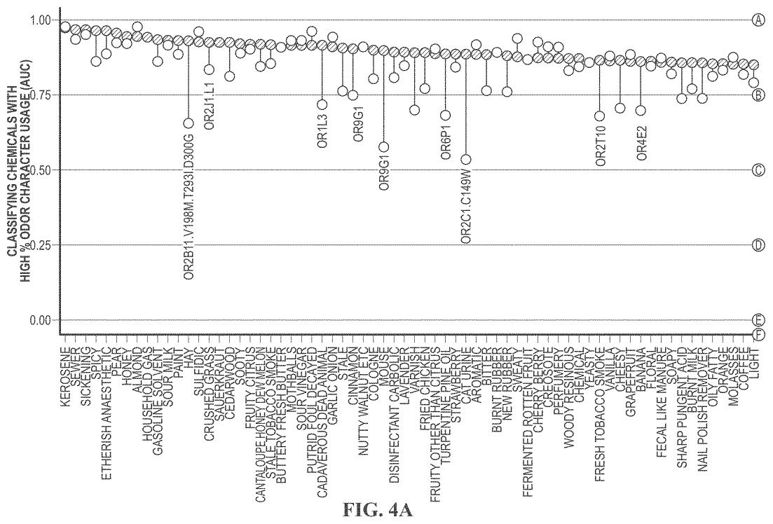

To visualize such a large chemical space in a 2D image is not feasible so only a tiny fraction of the predictions was represented as a network where each new predicted chemical (in red) is linked to its associated odor character (in blue) (FIG. 3A). Within these spaces, “communities” or clusters of related odor characters can be detected computationally based on subtle differences in connectivity as previously done with the ATLAS chemicals (FIG. 3B, top). It is simple to extract chemicals residing in each community and to compare the predicted profile relative to the larger network (FIG. 3B, bottom left and bottom right). The advantage of this approach over others is that a precomputed distance or similarity matrix is not required. These networks are therefore scalable, approximating spaces that a person encounters, and can store numerous attributes about the chemicals for data mining or predicting the attributes of new chemicals.

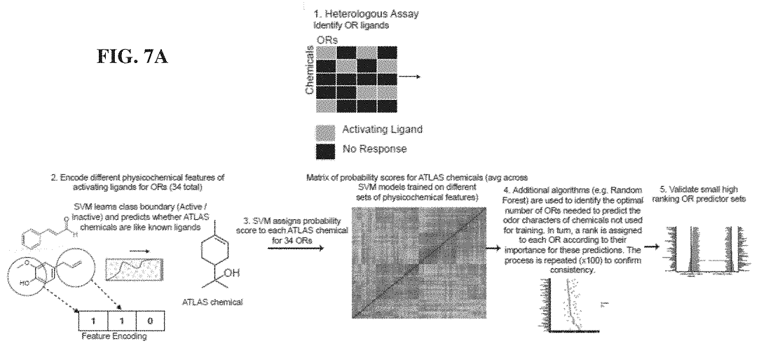

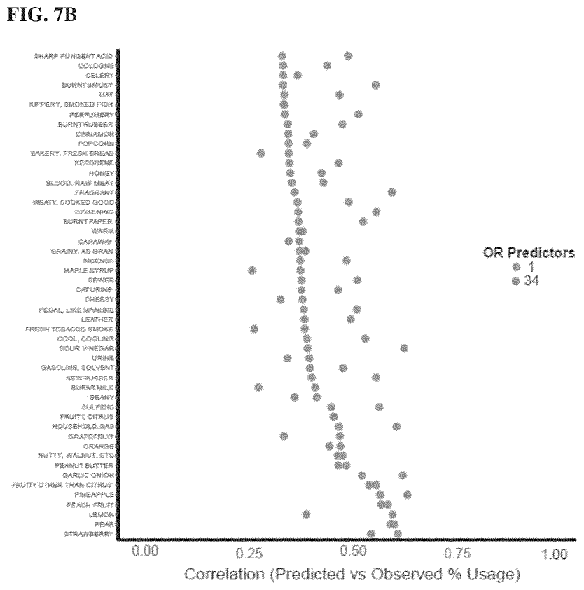

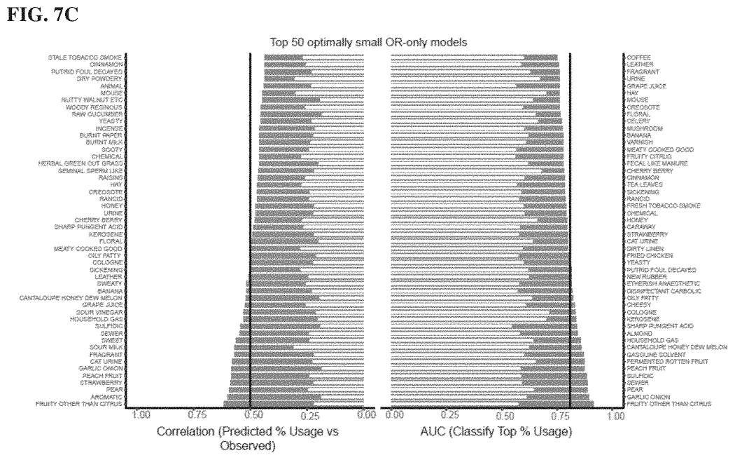

Efforts to predict human odor perception and reconstruct the percept space from molecular descriptors does not however offer insight into the model of biological coding, which depends not only on the mapping of important physicochemical features of odorants onto perception, but also specific olfactory receptor proteins. As a result, the extent was tested to which known human odorant responses from heterologous assays could be used in lieu of DRAGON descriptors. Each odorant receptor is likely activated by a unique set of chemicals, and together the large family can detect a vast chemical space, making this task suitable for computational modeling. Although comprehensive odor response profiles of most human ORs are not available yet, a database of 173 known ligands were compiled for 138 deorphanized human ORs (84 ORs and 54 allelic variants). Unfortunately, only the broadly tuned ORs have a sufficiently large number of ligands to incorporate activity in the form of EC50s and <25% of the ATLAS chemicals were known ligands for one or more ORs across the data surveyed. Before proceeding a way therefore had to be first found to identify cognate ORs that detect the other ATLAS compounds before analyzing their contributions to percepts. This was done in two ways. First, for 34 ORs sufficient numbers of odorants were known activators for us to train SVMs on OR-optimized physicochemical features. This allowed us to assign probability scores to all the ATLAS chemicals with unknown activity profiles and 1 or 0 to those with confirmed profiles across the 34 ORs (FIG. 7A). It was then evaluated whether activities of a subset of these ORs could predict any of the 146 odors character percepts. Surprisingly, a small percentage of the 34 ORs consistently proved useful in predictions of odor perception (FIGS. 7B and 7C).

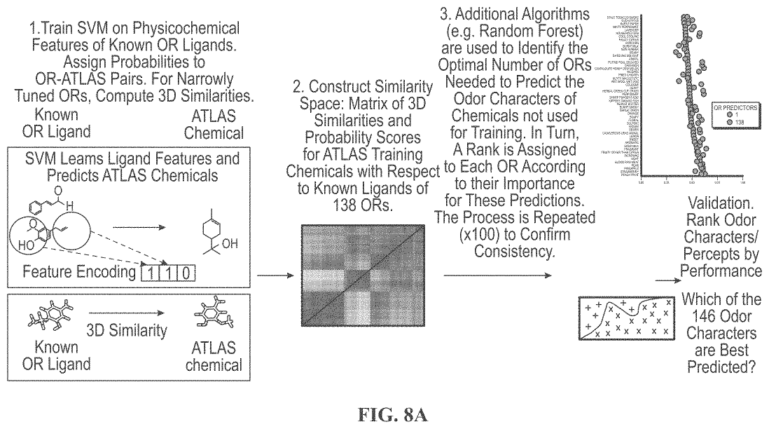

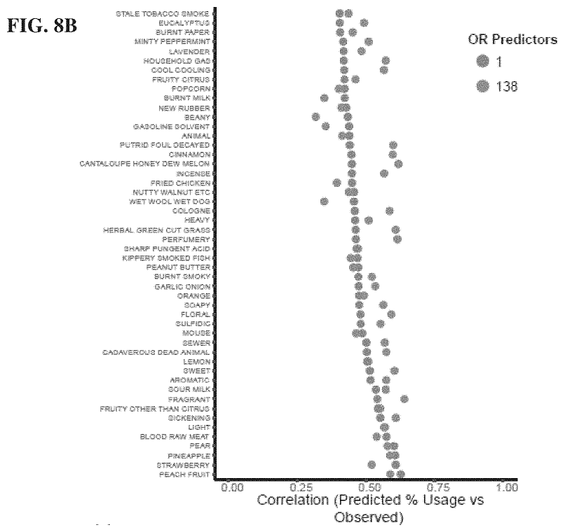

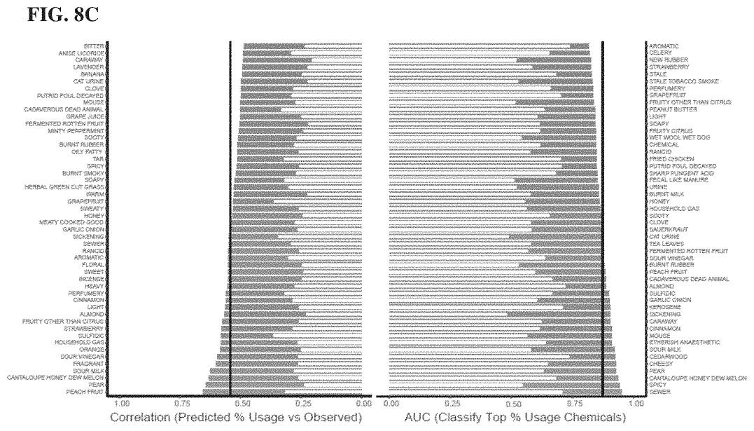

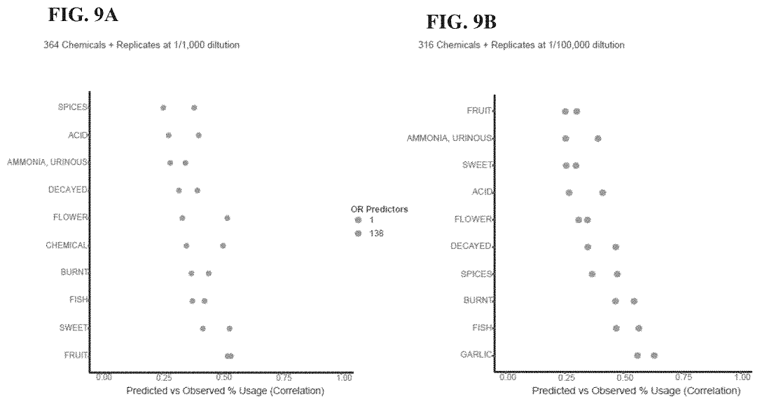

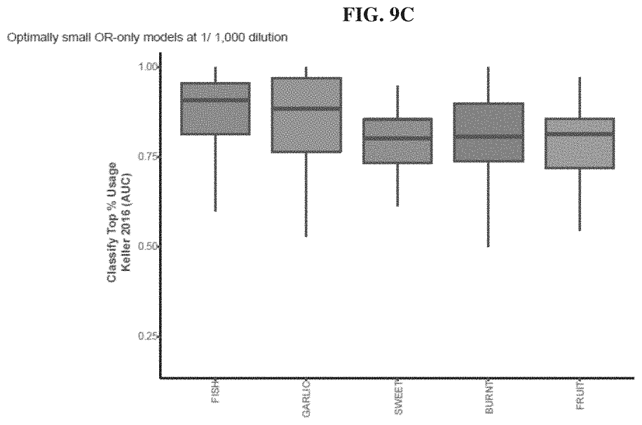

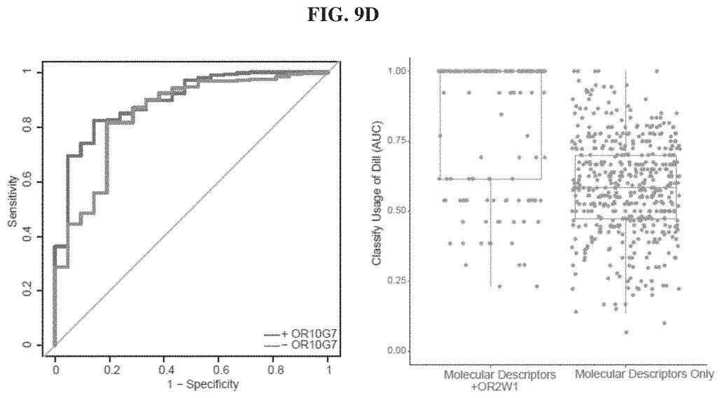

Second, we incorporated additional ORs with more narrowly tuned response profiles. Using the 1 or 2 ligands for these ORs as a guide, we computed 3D pharmacophores for each OR and assigned the maximum similarity to the ATLAS dataset chemicals, providing 104 additional ORs. The activities of these 138 ORs were subsequently tested for importance to each odor character (FIG. 8A). As before, random selection of a single OR could optimize predictions for some of the odor characters (FIG. 8B). When we investigated this further, identifying and evaluating small sets of the most important ORs from this larger pool, the conclusions were similar to 34 ORs. Namely, although some odor characters can be reasonably predicted by chance, a small number of ORs are not only favored but uniquely informative for many characters (FIG. 8C) (regression: top 50 best predicted odor characters, mean r=0.54; t=35.07, p<10⁻¹⁵; top 50 classification models: mean AUC=0.87; t=24.31, p<10⁻¹⁵). We further validated these results by identifying a small number of important ORs that consistently predicted perceptual responses (odor characters) from another behavioral study that used naíve volunteers (FIGS. 9A-9C). This represents only a quarter of the human ORs, and as more get deorphanized it was expected to find other OR-character relationships using the approach.

Since only few of the many human ORs tested were needed to optimize predictions of odor character, the ORs were next studied alongside the best DRAGON descriptors. Two test cases were selected before performing a large-scale analysis. The first in which OR10G7, an OR ranked highly for “cinnamon,” was added to the top DRAGON descriptors, suggesting that molecular descriptors while reasonably predictive could benefit from the additional OR information (mean AUC without 83% versus 91% with OR10G7 (FIG. 9D). The second case involved possibly improving a poor fit between molecular descriptors and the odor character dill. Although few human respondents in the ATLAS study used “dill,” and this likely contributed to poor predictions of the character from molecular descriptors, we found that the broadly-tuned, non-responding, OR2W1, could be added to DRAGON descriptors, noticeably improving predictions. No significant pairing was found between dill-smelling chemicals and a specific receptor; the improvement suggests that predictions of odor characters such as “dill” may benefit from a non-responding OR, presumably acting to rule out chemicals.

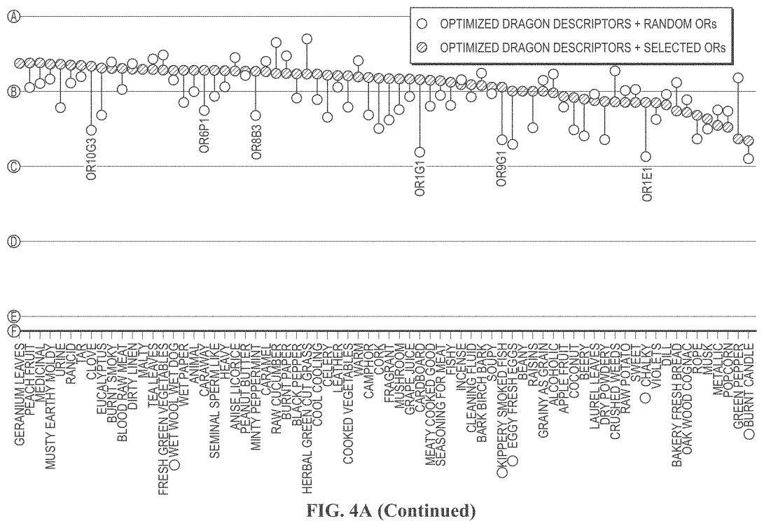

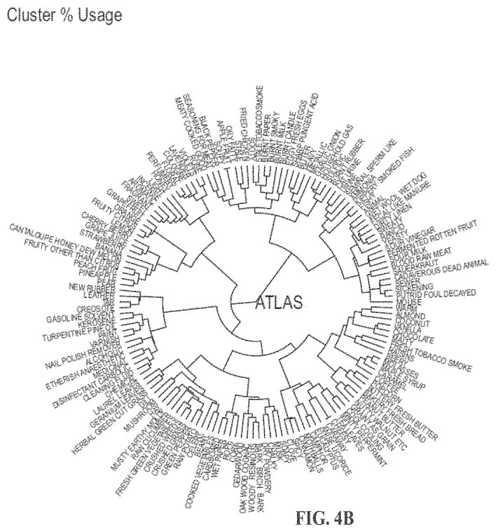

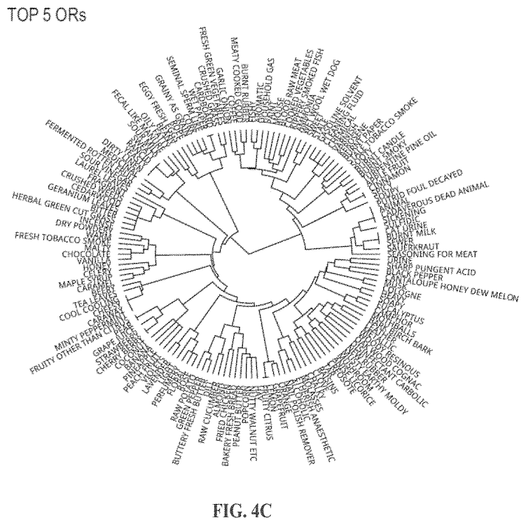

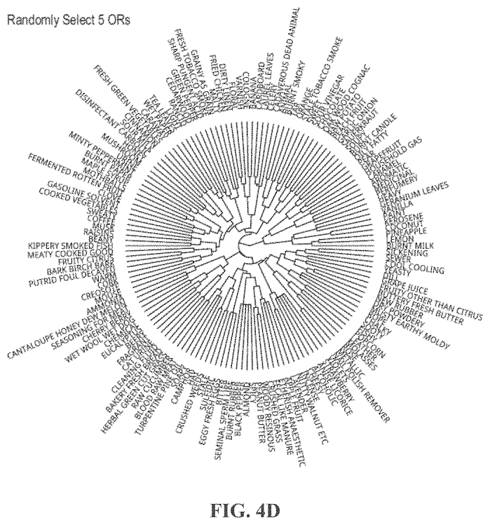

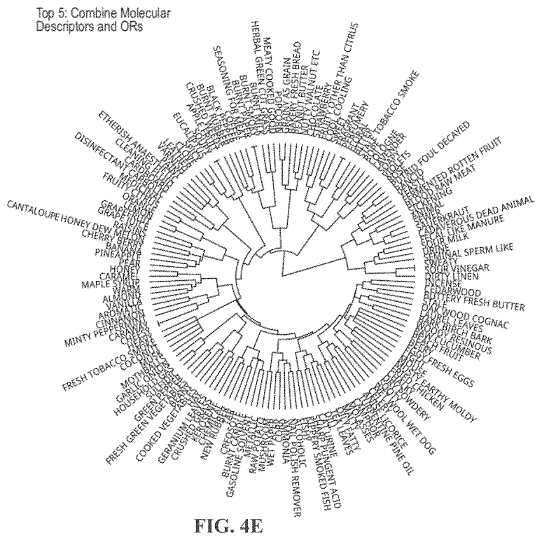

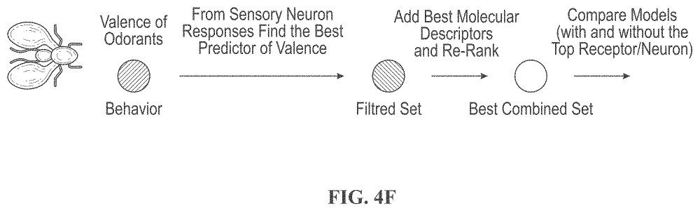

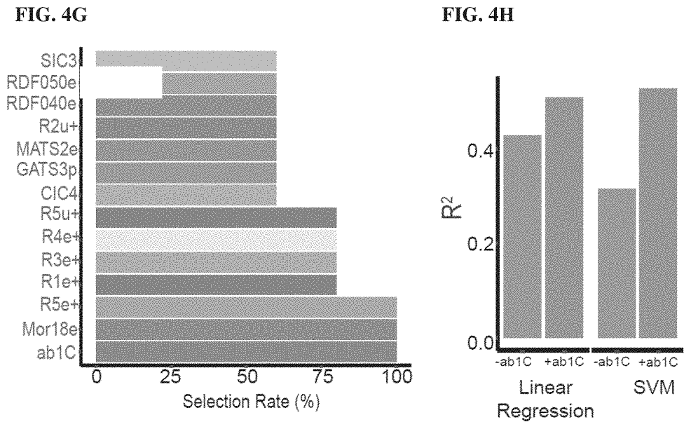

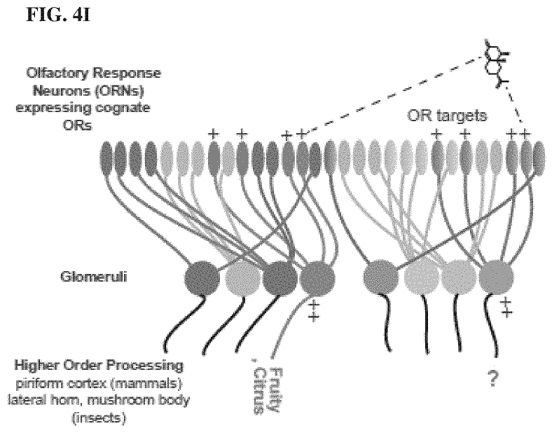

To determine if this was prevalent across the 146 odor characters, next the 138 ORs and ˜5000 DRAGON descriptors were added together and ranked the combined set. Although the molecular descriptors remained highly ranked, ORs were often included, at times in the top 5. Subsequently, the % usage of chemicals was classified with the best combined sets, selectively removing the contribution of ORs by introducing random values. Roughly half of the odor characters were better predicted with the combined OR and descriptor sets (AUC=0.83, p<0.0001) (FIG. 4A). This was also true when using alternative validation methods and metrics.

To test whether these 146 independent models were mapping the perceptual space, the top ORs and DRAGON descriptors as combinatorial codes were represented. The percept-receptor (FIG. 4C) and the combined (percept-chemical-receptor) trees (FIG. 4E) compared favorably to the perceptual data (FIG. 4B), particularly with respect to chance (FIG. 4D). Odor characters in the receptor-percept tree that matched the perceptual data poorly, in part because of generalist ORs, appear more accurately positioned in the combined tree, consistent with key ORs and molecular descriptors providing information that is increasingly unique and complementary. Hybrid (descriptor-OR) models will therefore yield further success as more human ORs get deorphanized, providing context for why certain molecular descriptors are reliably associated with specific odor characters.

This character—to—OR mapping has information from ˜20% of the human OR repertoire. In order to better understand the contribution of olfactory receptors to behavior we performed a more comprehensive analysis with the Drosophila melanogaster model system because in vivo odor-response spectra are known for the majority of ORs in the adults, as well as the behavioral valence (attraction vs aversion) to these odorants. It was asked whether the machine learning approach used for learning human odor characters generalized to learning behavioral valence of flies from physicochemical features (FIG. 4F). Indeed, it could be done with significant predictive success, identifying 13 optimal molecular descriptors. When the predictor selection algorithms used were provided with the combined set of these 13 DRAGON descriptors and electrophysiologically measured responses, the ab1C neuron response was selected as the top predictor (FIG. 4G). Removing ab1C adversely affected the model, and few DRAGON descriptors explained a large percentage of variability in odor valence scores whether fitting models using regularized linear regression or the more complex support vector machine (SVM) (FIG. 4H). In an earlier study it was shown that ab1C neuron activity was the top predictor of odorant valence across all 25 olfactory receptor neurons without incorporating any molecular descriptors. Accordingly, even when a more exhaustive receptor array is added, a small subset of the available receptors and molecular descriptors appear to be information-rich (FIG. 4I).

Both the human odor character and fly valence predictions support a model that odor identity arises early in the processing stream, at the olfactory receptors based on a high predictive success rate (˜76-91%). It is likely that the remaining portion depends on experience-dependent modulation, supporting a downstream model with reliance on distributed neuronal networks for human perceptual coding. Our findings support a “primacy model” which holds that a small number of distinct and overlapping olfactory receptor activity profiles encode odor identity. Although increasing concentration activates more receptors, the highest sensitivity receptors start responding first as an animal approaches an odor source and presumably continue to convey the identity. Such a model is consistent with the findings reported here and others because it appears that only a few ORs contribute to an odor character and it is therefore also tractable to learn from specific physicochemical properties of ligands. Nevertheless, it is unclear how information arising early in the olfactory pathway is preserved along the complex circuits and can in fact lead to generalizable perceptual features. The spatial organization of the olfactory receptor neurons and glomeruli are for one not well preserved in the piriform cortex. Unlike the retinotopic and tonotopic patterning observed in the visual and auditory cortices, representing spatiotemporal properties of visual and auditory stimuli as they are processed at sensory neurons, piriform activity appears randomly distributed, without a clear mapping of physicochemical features. A combination of computational models and calcium imaging has however shown piriform circuits, though they are qualitatively different, can support perceptual invariance amid changes in concentration and across different odorants. Similarly, neural tracing experiments in mice support that while olfactory circuitry differs from other sensory modalities, odor related-information is represented along equally structured neuroanatomical pathways, as in the piriform output projecting to the orbitofrontal cortex.

One simple possibility that has not escaped our attention is that only 1 or few receptors of the many that detect an odorant actually form a simple structural association with percepts. The evolutionary landscape should accordingly be coupled to biologically relevant or frequently encountered features of the chemical space, as implied by recent characterizations of receptors highly tuned for musk and onion-related compounds in addition to the highly conserved trace amine-associated receptors (TAARs) and their importance in modulating behavioral output in mice. In our analyses many of these specialized ORs were ranked highly but other ORs were possibly given priority for no other reason than a lack of similarity between its ligands and an odor character. Caution may be needed in interpreting these results, particularly due to sparsity in available human OR data and that the size and composition of the ATAS dataset is not exhaustive. Yet from these same considerations the results remain unexpected. The generalizability of molecular descriptors models across differing sample demographics and the mostly distinct odor panels suggests the available data are still quite robust.

This study was ultimately motivated by the limited data on human odor perception and to remedy limitations that are fundamental to human data collection. The physicochemical basis of odor characters was highlighted and previous efforts were built upon to model olfactory perception as a computational problem, but it has also been outlined how these techniques might be applied to facilitate data-driven theories about the human olfactory perceptual space and its physicochemical origins on a considerably larger scale. Network analysis within these spaces is likened to gene networks and therefore analytical tools that have been developed for large differential gene expression datasets are easily adapted to the perceptual coding task. Olfactory perceptual coding is multilevel, though it remains unclear how odor identity is represented at different processing levels. An emerging approach in network analysis has been the application of group detection algorithms for identifying potentially hidden global structure throughout multilevel networks. The infrastructure is, as a result, capable of integrating greater complexity than networks discussed here.

The molecular descriptors as reported for the different ATLAS percepts could provide a foundation for understanding odor coding and developing predictions of new chemicals that smell a specific way. Predicted compounds from the large computational screen are a rich source of information about our potential olfactory chemical space. Thus, this study provides a powerful approach for the discovery of new flavors and fragrances, a task that so far had relied primarily on areas of chemical synthesis.

Lengthy table referenced here
US20200399558A1-20201224-T00001
Please refer to the end of the specification for access instructions.

LENGTHY TABLES
The patent application contains a lengthy table section. A copy of the table is available in electronic form from the USPTO web site (https://seqdata.uspto.gov/?pageRequest=docDetail&DocID=US20200399558A1). An electronic copy of the table will also be available from the USPTO upon request and payment of the fee set forth in 37 CFR 1.19(b)(3).

What is claimed is:

1. A flavor/fragrance composition, comprising an effective amount of one or more compounds selected from Tables 1-42.

2. The flavor/fragrance composition of claim 1, wherein the composition is formulated as a spray, lotion, foam, gel, suspension, or emulsion.

3. The flavor/fragrance composition of claim 1 or 2, wherein the flavor/fragrance composition is added into a flavored/fragranced product.

4. The flavor/fragrance composition of claim 3, wherein the flavored/fragranced product is beverage, food, medicine or cosmetic.

5. The flavor/fragrance composition of claim 3 or 4, wherein the flavored/fragranced product further comprises an additional flavor and/or fragrance component.

6. The flavor/fragrance composition of any one of claims 1-5, wherein the flavor/fragrance composition has an odor that is associated with one or more substances selected from the group consisting of almond, anise/licorice, aromatic, banana, cantaloupe/honeydew, cedarwood, cherry/berry, cinnamon, clove, coconut, coffee, cologne, flower, fragrance, fresh tobacco/smoke, fruit/citrus, fruit other than citrus, garlic/onion, geranium leaves, herbal green/cut grass, incense, lavender, leather, lemon, medicine, mint/peppermint, musk, oak wood/cognac, orange, peach fruit, pear, perfume, pineapple, rose, soap, spice, strawberry, sweet, vanilla, violets, woody resinous, and combinations thereof.

7. The flavor/fragrance composition of any one of claims 1-6, wherein the flavor/fragrance composition imparts cooling sensation.

8. A method to computationally identify chemicals predicted for each percept, comprising using Dragon Physicochemical descriptors as shown in Table 43.
